(19) United States
(12) Patent Application Publication
(10) Pub. No.: US 2024/0300050 A1
(43) Pub. Date: Sep. 12, 2024

(54) LASER ETCHING SYSTEM FOR PATTERNING ELECTRODE LAYER AND METHOD THEREFOR

(71) Applicant: Quanzhou Shengwei Electronic Technology Co., Ltd., Quanzhou (CN)

(72) Inventors: Zuhui Chen, Quanzhou (CN); Qishan Weng, Quanzhou (CN); Wei Lin, Quanzhou (CN); Hongtao Tian, Quanzhou (CN); Yutang Huang, Quanzhou (CN); Qiuxia Zheng, Quanzhou (CN); Yuhui Lin, Quanzhou (CN); Yitong Yang, Quanzhou (CN); Li Wu, Quanzhou (CN)

(73) Assignee: Quanzhou Shengwei Electronic Technology Co., Ltd., Quanzhou (CN)

(21) Appl. No.: 18/243,532

(22) Filed: Sep. 7, 2023

(30) Foreign Application Priority Data
Mar. 10, 2023 (CN) 202310230347.4

(51) Int. Cl. B23K 26/067; B23K 26/14; B23K 26/362; B23K 26/70

(52) U.S. Cl. CPC B23K 26/067; B23K 26/14; B23K 26/362; B23K 26/703

(57) ABSTRACT

The present disclosure provides a laser etching system for electrode layer patterning, which can perform electrode layer patterning on the conductive layer of a first surface of the substrate of a double-sided structure touch panel by means of employing a laser beam without damaging the conductive layer on the second surface of the substrate. The system comprises a laser emitter for generating and emitting laser beams, and a laser etching platform for supporting and fixing the touch panel substrate, with the first surface facing the laser beam and the second surface adhering to the laser etching platform. The laser etching system further comprises optical elements, which ensure that the ratio of the spot size of the laser beam irradiated on the second surface to that irradiated on the first surface is not less than 1.2.

### CROSS-REFERENCE TO RELATED APPLICATION

This application claims priority to and benefit from Chinese Patent Application No. CN202310230347.4, filed Mar. 10, 2023, the disclosure of which is considered part of the disclosure of this application, and is incorporated by reference in its entirety into this application.

### TECHNICAL FIELD

The present disclosure relates to the field of touch screens, and relates in particular to a laser etching system for patterning an electrode layer and a method therefor.

### BACKGROUND

Touch screens are currently the simplest, most convenient, and most natural way of human-machine interaction, widely employed in information inquiries, industrial control, self-service, multimedia teaching, electronic games, and many other fields. Among various types of touch screens, capacitive touch screens occupy an important position due to their advantage in accuracy, wear resistance, and long life; moreover, they have a superior application prospect. Typically, a capacitive touch screen comprises a touch panel and a display screen that are fixedly connected to each other at their edge portions by means of an adhesive member (such as double-sided tape, adhesive, etc.). The touch panel is the screen part that provides touch functionality, while the display screen is the screen part that provides display functionality.

The touch panel can be a single-sided or a double-sided structure, while the present disclosure only relates to double-sided structure touch panels. In the prior art, a double-sided structure touch panel based on the mutual capacitance concept is shown in FIG. 1. The touch panel 1 has a generally transparent substrate, such as glass or PET. On one surface of the substrate (the front side in FIG. 1, i.e., the surface facing outward from the paper), multiple rows of drive conductive lines are sequentially arranged, as is shown by the drive conductive line 20, which form the driving electrode layer of the double-sided structure touch panel 1. On the other surface (the backside in FIG. 1, i.e., the surface facing inward from the paper, with structures arranged on the backside shown in dashed lines), multiple columns of sensing conductive lines are sequentially arranged, as is shown by the sensing conductive line 10 which form the sensing electrode layer of the double-sided structure touch panel 1. That is, two electrode layers, a driving electrode layer and a sensing electrode layer, are formed on two surfaces of the substrate of the double-sided structure touch panel, respectively; they are usually implemented by forming a conductive layer of materials such as ITO, IGZO, PEDOT, nanosilver wire, metal grid, etc., on both surfaces of the substrate and then patterning the conductive layer.

The patterning of the electrode layer of the double-sided structure touch panel is usually implemented by means of a conventional process in the industry, such as photolithography and dry processes (i.e., employing etching paste). However, the laser process suitable for single-sided structure touch panels is not applicable (touch panels with an electrode layer formed on only one surface of their substrate), due to penetration of the substrate (which is very thin, generally between 0.3-1.1 mm) by the laser beam applied to pattern the conductive layer on one surface of the substrate to form the electrode layer, thus affecting the touch function of the touch panel product.

On the other hand, both photolithography and dry processes have problems with complex processes, high costs, and environmental pollution, which are not conducive to energy saving and emission reduction. In contrast, laser processes have the advantages of simple processes, high production precision, precise controllability, low cost, and without environmental pollution. Therefore, how to apply laser processes to the patterning of the electrode layers of double-sided structure touch panels has become a pressing issue that urgently demands breakthrough and development in the prior art.

As a result, technicians in this field are striving to develop a laser etching system for patterning an electrode layer and a method therefor, in particular those suitable for patterning the electrode layers of double-sided structures.

### SUMMARY

To achieve the aforementioned object, the present disclosure, in one aspect, provides a laser etching system for patterning the electrode layer on the conductive layer of the first surface with a laser beam without damaging the conductive layer on the second surface of the substrate of a touch panel with a double-sided structure. The system includes a laser, for generating and emitting the laser beam; and a laser etching platform, for accommodating and fixing the substrate of the touch panel, such that the first surface faces the laser beam and the second surface is attached to the laser etching platform. The laser etching system further includes an optical component rendering the ratio of the light spot area of the laser beam irradiated on the second surface to the light spot area irradiated on the first surface to be not less than 1.2.

Further optionally, the ratio of the light spot area irradiated by the laser beam on the second surface to the light spot area irradiated on the first surface is 1.2-20.

Further optionally, the ratio of the light spot area of the laser beam irradiated on the second surface to the area of the spot irradiated on the first surface is not less than 1.5.

Further optionally, the ratio of the light spot area irradiated by the laser beam on the second surface to the light spot area irradiated on the first surface is not less than 1.8.

Further optionally, the ratio of the light spot area irradiated by the laser beam on the second surface to the light spot area irradiated on the first surface is not less than 2.

Optionally, the laser etching system has multiple lasers, and the multiple laser beams come from the multiple lasers.

Optionally, the laser beam is a plurality of laser beams, the light spots irradiated on the first surface by the plurality of the laser beams overlap, and the light spots irradiated thereby on the second surface are separated from one another.

Further, the plurality of the laser beams, or at least one of the plurality of the laser beams incident on the first surface, enter the first surface at an angle relative thereto in less than 90°.

Further, the plurality of the laser beams, or at least one of the plurality of the laser beams incident on the first surface, enter the first surface at an angle relative thereto no more than 60°.

Further, at least a portion of the optical component is implemented as a laser vibrating mirror.

Optionally, the optical element further comprises a lens, which makes the laser beam passing through it form a positive defocused laser beam focused outside the substrate, and the positive defocused laser beam irradiates on the second light spot area at the surface is larger than the light spot area irradiated at the first surface.

Further, the laser beam is incident on the first surface at an angle relative thereto less than 90°.

Further, the laser beam is incident on the first surface at an angle relative thereto no more than 60°.

Further optionally, the laser beam is a plurality of laser beams, the light spots irradiated on the first surface by the plurality of the laser beams overlap, and the light spots irradiated thereby on the second surface are separated from one another.

Further optionally, the laser etching system has multiple lasers, and the multiple laser beams come from the multiple lasers.

Further optionally, at least two laser beams among the plurality of laser beams are formed by splitting a laser beam from one laser through a beam splitter.

Further, the laser etching system further comprises a blower, which is employed to provide cooling gas flow to the spot position where the laser beam is irradiated on the first surface.

Further, the blower employs liquid nitrogen as a cooling source to provide the cooling gas flow.

Further, the laser etching system also comprises a cooling device, which is employed to provide a coolant flow to the spot position where the laser beam is irradiated on the second surface, wherein the temperature of the coolant flow is lower than that of the cooling gas by at least 14° C.

Further, the cooling device employs solid nitrogen as a cooling source to provide the coolant flow.

Further, at least one recess is formed on the surface of the laser etching platform that is attached to the second surface of the substrate, and the recess is arranged to be adjacent to the spot position where the laser beam is irradiated on the second surface, and the coolant flow is introduced into the recess to provide cooling at a spot location where the laser beam irradiates on the second surface.

Further, the cooling device is a cooling circulation device connected to the recess via a coolant inlet pipe and a coolant return pipe, and the coolant flow enters the recess from the cooling device through the coolant inlet pipe, and then returns to the cooling device through the coolant return pipe.

In a second aspect, the disclosure provides a laser etching method for electrode layer patterning, which comprises: setting the optical components so that the ratio of the light spot area of the laser beam irradiated on the second surface to the light spot area irradiated on the first surface is not less than 1.2, by means of employing the laser etching system for electrode layer patterning as described above in the present disclosure, and then patterning the conductive layer on the first surface of the substrate by means of employing the laser beam.

As can be seen, the laser etching system and the method for electrode layer patterning of the present disclosure, by means of irradiating on the double-sided structure touch panel by employing a laser beam, render the ratio of the light spot area of the laser beam irradiated on the second surface to the light spot area irradiated on the first surface to be not less than 1.2, thus significantly reducing the energy density of the laser beam irradiated on the second surface, and avoiding damage to the conductive layer on the second surface during the patterning process of the conductive layer on the first surface. In addition, the laser etching system and the method for electrode layer patterning of the present disclosure employ a blower to provide a cooling gas flow to the spot location where the laser beam irradiates the first surface, cooling the temperature at that spot location and removing the conductive layer portion that has been ablated. The laser etching system and the method for electrode layer patterning of the present disclosure also employ a cooling device that provides a coolant flow with a temperature lower than that of the cooling gas flow to the spot location where the laser beam irradiates the second surface, further protecting the conductive layer on the second surface of the substrate from laser beam damage. Therefore, it can be seen that the laser etching system and the method for electrode layer patterning of the present disclosure can be applied to touch panels with a double-sided structure, wherein the laser beam does not damage the conductive layer on one surface of the touch panel substrate during etching of the conductive layer on the other surface, thus achieving electrode layer patterning of double-sided touch panels employing laser processing.

The following further explanations on the concept, specific structure, and technical effects of the present disclosure will be made in conjunction with the accompanying drawings to fully understand the purpose, features, and effects of the present disclosure.

### BRIEF DESCRIPTION OF THE DRAWINGS

FIG. 1 schematically shows a double-sided touch panel structure.

FIG. 2 shows the patterning of the conductive layer on the upper surface of the double-sided touch panel employing the laser etching system for electrode layer patterning according to an embodiment of the present disclosure.

FIG. 3 shows the structure of the laser etching system for electrode layer patterning shown in FIG. 2.

FIG. 4 schematically shows the laser beam for patterning the electrode layer of the double-sided touch panel in the embodiment shown in FIG. 2.

FIG. 5 schematically shows the laser beam for patterning the electrode layer of the double-sided touch panel in another embodiment.

FIG. 6 schematically shows the laser beam for patterning the electrode layer of the double-sided touch panel in another embodiment.

FIG. 7 schematically shows the laser beam for patterning the electrode layer of the double-sided touch panel in another embodiment.

### DETAILED DESCRIPTION OF THE INVENTION

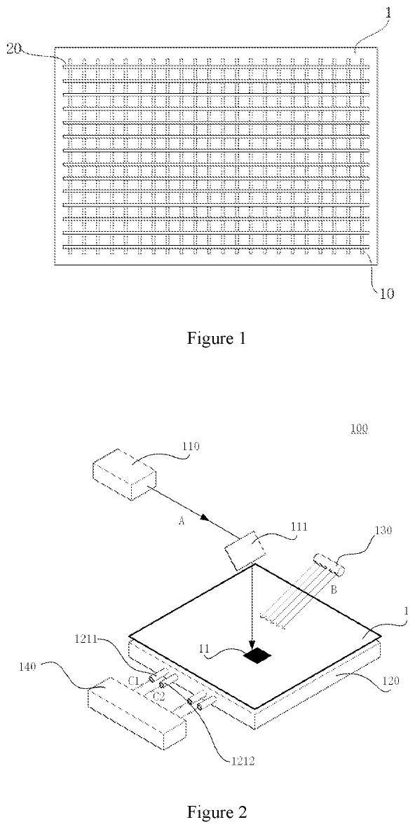

As shown in FIGS. 2-4, in an embodiment, the present disclosure provides a laser etching system 100 for electrode layer patterning, which is suitable for the patterning of electrode layers of a double-sided touch panel. In the embodiment, the laser etching system 100, comprising a laser 110, a laser etching platform 120, an air blower 130, and a cooling device 140, patterns the conductive layer on the surface of the substrate 12 of the double-sided touch panel 1 (i.e., etching) to form the required electrode layer.

Specifically, the laser 110 generates and emits a laser beam A for electrode layer patterning. The laser beam A can be focused to a suitable spot size (usually related to the resolution of the desired pattern) and directed to the area of the conductive layer to be patterned. The focused laser beam has suitable energy for etching away unwanted parts of the conductive layer, leaving behind the conductive layer portion with the desired pattern.

The laser beam A emitted by the laser 110 is irradiated onto the substrate 12 on the laser etching platform 120 subsequent to passing through several optical components. These optical components may comprise optical elements for guiding, focusing, adjusting the beam path, adjusting the angle of incidence, adjusting the intensity, converging, or separating the laser beam A, such as beam expanders, refractive mirrors, laser galvanometers, and field lenses.

In the embodiment, the optical element implemented as a laser galvanometer 111 (e.g., a scanning galvanometer from Germany's Scanlab, a Holo/Or laser galvanometer, etc.) is employed to adjust the optical path of the laser beam A so that it can be irradiated onto the conductive layer area to be etched; and an optical element such as a lens 112 is employed to form the laser beam A into a positive defocused laser beam, i.e., the laser beam A with the laser focus above the conductive layer area to be etched, as shown in FIG. 4. The lens 112 can be integrated into the laser galvanometer 111 or be a supplemental lens. In the embodiment, the lens 112 in the laser galvanometer 111 forms the laser beam A into a positive defocused laser beam. For clarity of illustration, they are shown separately. Also, for the same purpose of clarity, optical elements such as beam expanders, refractive mirrors, laser galvanometers, field lenses, etc., arranged on the optical path of the laser beam A are omitted.

In this way, through the above-mentioned optical elements, the area S2 of the light spot formed by the laser beam A irradiating the lower surface of the substrate 12 is larger than the area S1 of the light spot formed by the laser beam A irradiating the upper surface of the substrate 12, thus reducing the energy density of the laser beam A at the lower surface of the substrate 12 and making it less likely to damage the conductive layer on the lower surface of the substrate 12. Preferably, the light spot area S2 is 1.2-20 times the light spot area S1.

The laser etching platform 120 is responsible for supporting and fixing the touch panel 1 during the laser etching process, so that through its own relative movement to the laser beam A (for example, the controlled movement of the laser etching platform 120, or the controlled movement of the laser beam A's guiding device (such as the above-mentioned optical components), or both), the relative movement of the laser beam A and touch panel 1 is realized during the laser etching process, so that the laser beam A can sequentially irradiate the conductive layer area that needs to be patterned on the touch panel for etching.

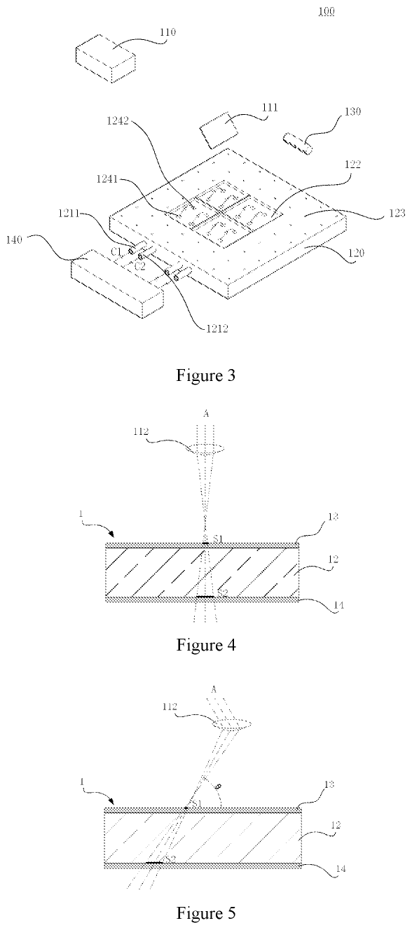

In the embodiment, the laser etching platform 120 fixes the touch panel 1 by negative pressure adsorption, as shown in FIG. 3. The surface of the laser etching platform 120 for supporting the touch panel 1 (the upper surface shown in the figure) has multiple vacuum adsorption holes 123, which are connected to the internal cavity of the laser etching platform 120, and the internal cavity is connected to an external air pump (not shown) to form an internal negative pressure. Therefore, when the touch panel 1 is placed on the upper surface of the laser etching platform 120, the negative pressure internal cavity will generate a downward adsorption force on the touch panel 1 via the vacuum adsorption holes 123, thereby firmly adsorbing the touch panel 1 onto the laser etching platform 120.

The blower 130 has at least one blowing port for blowing a cooling gas stream B, such as a cooled air stream, onto the conductive layer part being laser-etched on the touch panel 1 during the laser etching process, thereby removing the heat and conductive layer residue generated during the laser etching. In the embodiment, the blowing port of the blower 130 can automatically align with the position of the laser etching, for example, via the controller of the blower 130 or via the controller of the laser etching system 100, so as to precisely blow the cooling gas stream B to that position.

The cooling device 140 provides a coolant flow, such as a cooled water flow, to the laser etching platform 120, with the temperature of the coolant flow being lower than that of the cooling gas stream mentioned above, thereby providing further cooling to the touch panel 1 during the laser etching process, especially to its lower surface. Specifically, the upper surface of the laser etching platform 120 has at least one (four shown in FIG. 3) recess 122, and the position of the recess 122 is set to be close to the area that may be laser etched on the lower surface of the touch panel 1 fixed on the laser etching platform 120, that is, the position area where the laser beam A will pass through the substrate 12 and irradiate its lower surface. Generally, the recess 122 is located in the middle part of the upper surface of the laser etching platform 120, and the aforementioned vacuum adsorption holes 123 are distributed around the recess 122. Preferably, the depth of the recess 122 is no more than 5 cm.

Each recess 122 is equipped with at least one coolant inlet 1241 and at least one coolant outlet 1242, through which the coolant inflow C1 from the cooling device 140 enters the recess 123 via the corresponding coolant inlet pipeline 1211 and coolant inlet 1241, cools the area on the lower surface of the adjacent touch panel 1, and then returns to the cooling device 140 as the coolant outflow C2 through the corresponding coolant outlet 1242 and coolant return pipeline 1212. In the embodiment, one coolant inlet 1241 in a recess 122 corresponds to one coolant inlet pipeline 1211, and one coolant outlet 1242 in a recess 122 corresponds to one coolant return pipeline 1212. In this way, the recess 122 that takes an input of the coolant is selected according to the area being laser-etched on the touch panel 1. The valves of the corresponding coolant inlet pipeline 1211 and coolant return pipeline 1212 are opened, allowing the coolant to circulate only through the coolant inlet pipeline 1211 and coolant return pipeline 1212, as well as the corresponding coolant inlet 1241 and coolant outlet 1242, between the cooling device 140 and the selected recess 122, thus saving the consumption of coolant.

As described above, the cooling device 140 employed in the embodiment is a cooling circulation device, which is conducive to energy saving. However, those skilled in the art can understand that in other embodiments, the cooling device 140 can also be a single-function coolant source, providing only coolant inflow without receiving coolant return flow. In such a case, an additional device can be set up to receive the coolant return flow.

When employing the laser etching system 100 for electrode layer patterning according to the present disclosure, the substrate 12 of the double-sided structured touch panel 1 is first placed on the laser etching platform 120, as shown in FIG. 2. Under the action of an external air pump, the substrate 12 is firmly adsorbed on the upper surface of the laser etching platform 120.

As shown in FIG. 4, both surfaces of the substrate 12 are formed with conductive layers, with the upper surface (i.e., the upward-facing surface shown in FIGS. 2 and 4, away from the laser etching platform 120) having a conductive layer 13, and the lower surface of the substrate 12 (i.e., the downward-facing surface shown in FIGS. 2 and 4, facing and attached to the laser etching platform 120) having a conductive layer 14. Here, the conductive layer 13 on the upper surface of the substrate 12 is laser-etched, while the conductive layer 14 can be either an unetched conductive layer or an electrode layer formed subsequent to laser etching.

Next, set the operating parameters of the laser 110 and adjust the optical path of the laser beam A emitted by the laser 110 via the laser galvanometer 111, so that it can irradiate the conductive layer area to be etched on the upper surface of the substrate 12 with an appropriate spot size and energy density. This step can be completed before placing and fixing the touch panel 1, or simultaneously.

2) In the embodiment, a 1064 nm laser is employed, with the frequency of the laser galvanometer 111 set to 300-500 KHz, the scanning speed to 2000-3000 mm/s, and 32% of the 30-watt laser is employed for etching (in other embodiments, the laser power can be 20-30 watts, set to 10%-50% for etching), thus avoiding possible damage to the conductive layer on the lower surface of the substrate 12 due to excessively high laser power. In addition, in the embodiment, a vertically incident (i.e., the angle of the laser beam A relative to the surface of the substrate 12 is 90°) laser beam A is employed to irradiate and etch the conductive layer on the surface of the substrate 12, and the focusing position of the laser beam A above the substrate 12 is set so that the light spot area S2 formed at the lower surface of the substrate 12 is 1.5-5 times the light spot area S1 formed at the upper surface of the substrate 12. In other embodiments, the light spot area S2 can be set to be not less than 1.2 times, 1.5 times, 1.8 times, or 2 times the light spot area S1, and/or not more than 20 times the light spot area S1.

Next, set the operating parameters of the blower 130, comprising the temperature and flow rate of the cooling gas stream B it blows out. Similarly, this step can be performed before or simultaneously with the aforementioned steps.

In the embodiment, liquid nitrogen is employed as the cooling source for the blower device 130, and the air cooled by liquid nitrogen is blown out by the blower 130 to form a cooling gas stream B with a temperature between −196° C. and 30° C. and a flow rate of 0.5 m/s-30 m/s.

Next, set the operating parameters of the cooling device 140, comprising the temperature and flow rate of the coolant it provides, as well as the valves of the coolant inlet pipeline 1211 and coolant return pipeline 1212 to be opened. Similarly, this step can be performed before or simultaneously with the aforementioned steps.

In the embodiment, solid-state nitrogen is employed as the cooling source for the coolant, and the liquid (such as water) cooled by the solid-state nitrogen is output by the cooling device 140 to one or more selected recesses 122 on the laser etching platform 120. The output coolant temperature in flow C1 is between −210° C. and 30° C., with a flow rate of 0.5 m/s-30 m/s.

After completing the above settings, the laser 110, the blower 130, and the cooling device 140 can be turned on to start the patterning of the conductive layer 13 on the upper surface of the substrate 12 of the touch panel 1, i.e., laser etching. Specifically, the laser beam A emitted by the laser 110 is guided to irradiate the conductive layer 13 and pattern it according to the pre-set pattern, etching and removing a portion of the conductive layer 13. The blower 130 automatically aligns the blowing nozzle with the laser etching location, quickly dissipating the heat from the upper surface of the substrate 12 and reducing the adverse effects of laser energy on the conductive layer 14 on the lower surface of the substrate 12. At the same time, the cooling device 140 provides circulating coolant to quickly remove the heat generated by the laser irradiating the conductive layer 14 on the lower surface of the substrate 12, avoiding damage to the conductive layer 14 on the lower surface of the substrate 12.

As the laser beam A is formed into a positive defocus laser beam, the ratio of the light spot area S2 formed at the lower surface of the substrate 12 to the light spot area S1 formed at the upper surface of the substrate 12 is not less than 1.2, and since the temperature of the coolant flow C1 flowing near the lower surface of the substrate 12 is lower than that of the cooling gas flow B flowing near the upper surface of the substrate 12, the laser beam A can normally etch and remove a part of the conductive layer 13 on the upper surface of the substrate 12 without affecting the conductive layer 14 on the lower surface of the substrate 12. As a result, the conductive layer portion with the desired pattern (e.g., conductive layer portion 11 in FIG. 2) is finally left on the upper surface of the substrate 12, forming the required electrode layer.

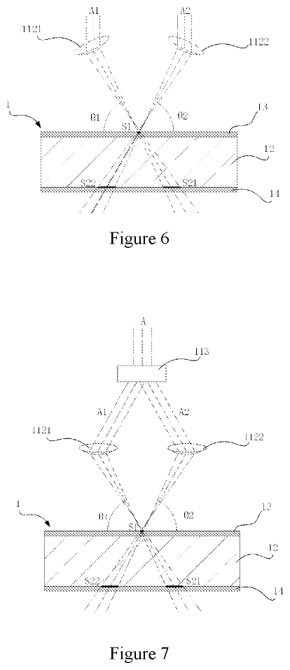

In other embodiments, the light spot area S2 on the lower surface can be further enlarged relative to the light spot area S1 on the upper surface by adjusting the incident angle θ of the laser beam A relative to the surface of the substrate 12, as shown in FIG. 5. For clarity and convenience in illustration, the refraction of the obliquely incident laser beam within the substrate is not shown in FIG. 5 and subsequent FIGS. 6 and 7.

At this point, the incident angle θ of the laser beam A is less than 90°, and as the incident angle θ decreases, the ratio of the lower surface light spot area S2 to the upper surface light spot area S1 will increase, thereby reducing the energy density of the laser beam A irradiating the lower surface of substrate 12. Preferably, the incident angle θ is no more than 60°. By adjusting the incident angle θ, it is possible to achieve a lower surface light spot area S2 formed by laser beam A on the lower surface of substrate 12, which is 1.5-10 times the upper surface light spot area S1 formed on the upper surface of substrate 12. In other embodiments, the spot area S2 can be set to be not less than 1.2 times, 1.5 times, 1.8 times, 2 times, and/or not more than 20 times the light spot area S1.

In addition, as shown in FIGS. 6 and 7, multiple (two shown) laser beams A1 and A2 can be employed to irradiate the substrate 12 of the touch panel 1. These two laser beams A1 and A2 can come from two separate lasers, as shown in FIG. 6; or they can be formed by splitting a laser beam A from a single laser employing a beam splitter 113, as shown in FIG. 7. The two laser beams A1 and A2 are focused by their respective lenses 1121 and 1122 into positive defocus laser beams, irradiating the conductive layer 13 of the upper surface of substrate 12 at incident angles θ1 and θ2, respectively. Moreover, the two laser beams A1 and A2 have overlapping spots at the upper surface conductive layer 13 with a light spot area of S1, and separated spots at the lower surface conductive layer 14 with light spot areas of S21 and S22, thus the lower surface light spot area S2=S21+S22. This allows for a further increase in the ratio of the lower surface light spot area S2 to the upper surface light spot area S1, for example, the lower surface light spot area S2 formed by the laser beams A1 and A2 at the lower surface of substrate 12 is 1.5-20 times the upper surface light spot area S1 formed at the upper surface of substrate 12. In other embodiments, the light spot area S2 can be set to be not less than 1.2 times, 1.5 times, 1.8 times, 2 times, and/or not more than 20 times the light spot area S1. Additionally, by reducing incident angles θ1 and θ2, this ratio can be further increased.

In the two embodiments shown in FIGS. 6 and 7, the two laser beams A1 and A2 have overlapping spots at the upper surface of substrate 12. Therefore, the laser energy density experienced at the etching position of the upper surface conductive layer 13 is the sum of the energy densities of the two laser beams at that position. As a result, these two laser beams A1 and A2 should have energy densities lower than the laser beam A in the embodiment shown in FIG. 5. For example, when the incident angles are the same, the energy densities of the laser beams A1 and A2 in the embodiment shown in FIG. 6 can be half the energy density of the laser beam A in the embodiment shown in FIG. 5. Furthermore, when the incident angles are the same, the laser beams A1 and A2 in the embodiment shown in FIG. 6 can be formed by splitting the laser beam A in the embodiment shown in FIG. 5 via the optical elements such as the beam splitter 113.

It should be noted that, as mentioned earlier, the commonly employed optical components in this field for adjusting the optical path of the laser beam to irradiate the area of the conductive layer that needs to be etched are implemented as laser galvanometers. Therefore, when employing two or more laser beams as described above to etch the upper surface conductive layer, it is necessary to properly set the parameters of the laser galvanometers for these laser beams so that they can operate in coordination, maintaining the overlap of these laser beams on the upper surface spots and separation on the lower surface spots during the scanning etching process of the upper surface conductive layer.

Alternatively, these laser galvanometers can be made not to perform scanning operations, that is, to keep their optical scanning heads stationary relative to, for example, the laser during the etching process, and to achieve the successive etching of the conductive layer areas to be etched by driving the laser etching platform. Such a method can simplify the setup of the laser galvanometers, but generally speaking, the approach of moving the laser etching platform by setting up the motor is not as accurate and fast as employing laser galvanometers.

In addition, those skilled in the art can understand that although the above description is an example of how to employ multiple laser beams with two inclined incident positive defocus laser beams to achieve patterning of the conductive layer on one surface (the first surface) of the substrate of a double-sided structure touch panel without damaging the conductive layer on the other surface (the second surface), it is also possible to allow one of the laser beams to be incident vertically by properly adjusting (for example, via optical elements such as apertures and lenses) the spot size of the laser beam on the first surface. Moreover, those skilled in the art can understand that when employing multiple laser beams to achieve the above purpose, it is not necessarily required to employ positive defocus laser beams, as long as the spots of these multiple laser beams overlap on the first surface and separate on the second surface, ensuring that the energy density of the laser beam at the spot on the first surface is greater than that on the second surface, thereby etching the conductive layer on the first surface without damaging the conductive layer on the second surface.

The above-detailed description provides some embodiments of the present disclosure. It should be understood that those of ordinary skill in the art can make numerous modifications and variations without inventive effort based on the concept of the present disclosure. Therefore, all technical solutions that can be obtained by those skilled in the art through logical analysis, reasoning, or limited experimentation based on the concept of the present disclosure and the prior art should be within the scope of protection defined by the claims.

1. A laser etching system for electrode layer patterning, capable of patterning an electrode layer on a first surface of a substrate of a double-sided structured touch panel employing laser beams without damaging the electrode layer on a second surface of the substrate, comprising:
a laser emitter for generating and emitting a laser beam; and
a laser etching platform for supporting and fixing the substrate of the touch panel, with the first surface facing the laser beam and the second surface attached to the laser etching platform;
wherein the laser etching system further comprises an optical element, which enables a ratio of a light spot area of the laser beam formed on the second surface to a light spot area formed on the first surface to be no less than 1.2.

2. The laser etching system of claim 1, wherein the laser beam includes a plurality of laser beams, with light spots of the plurality of the laser beams coinciding on the first surface and separated from each other on the second surface of the substrate.

3. The laser etching system of claim 2, wherein at least one of the laser beams has an incident angle, relative to the first surface of the substrate, less than 90 degrees.

4. The laser etching system of claim 1, wherein the optical element causes the laser beam to form a positive defocused laser beam outside of the substrate, wherein the positive defocused laser beam has the light spot area formed on the second surface greater than the light spot area formed on the first surface.

5. The laser etching system of claim 4, wherein the positive defocused laser beam has an incident angle, relative to the first surface of the substrate, less than 90 degrees.

6. The laser etching system of claim 4, wherein the laser beam includes a plurality of laser beams, and light spots of the plurality of the laser beams overlap on the first surface and are separated from each other on the second surface.

7. The laser etching system of claim 6, wherein at least one of the plurality of the laser beams is incident on the first surface at an angle less than 90 degrees relative to the first surface.

8. The laser etching system of claim 2, wherein the laser etching system has a plurality of lasers, and each of the plurality of the laser beams is emitted from a respective laser of the plurality of the lasers.

9. The laser etching system of claim 2, wherein at least two of the plurality of laser beams are formed by splitting a laser beam from one laser employing a beam splitter.

10. The laser etching system of claim 1, further comprising a blower for providing a cooling gas flow to a light spot position where the laser beam is incident on the first surface.

11. The laser etching system of claim 10, further comprising a cooling device, which is employed to provide a cooling agent flow to a position of a light spot on the second surface where the laser beam is incident, wherein a temperature of the cooling agent flow is at least 14° C. lower than a temperature of the cooling gas flow.

12. The laser etching system of claim 11, wherein at least one recess is formed on a surface of the laser etching platform that is in contact with the second surface of the substrate, and the recess is set adjacent to the position of the light spot where the laser beam is incident on the second surface; the cooling agent flow is introduced into the recess to provide cooling at the position of the light spot where the laser beam is incident on the second surface.

13. The laser etching system of claim 12, wherein the cooling device is a cooling circulation device, which is connected to the recess via a cooling agent inlet pipe and a cooling agent return pipe, and the cooling agent flow enters the recess through the cooling agent inlet pipe from the cooling device and then returns to the cooling device through the cooling agent return pipe.

14. A laser etching method for electrode layer patterning employing the laser etching system of claim 1, comprising:
setting an optical element of a laser etching system, such that a ratio of a light spot area of the laser beam formed on the second surface to a light spot area formed on the first surface is not less than 1.2; and
employing the laser beam to pattern the electrode layer on the first surface of the substrate.

15. The laser etching system of claim 6, wherein the laser etching system has a plurality of lasers, and each of the plurality of the laser beams is emitted from a respective laser of the plurality of the lasers.

16. The laser etching system of claim 6, wherein at least two of the plurality of laser beams are formed by splitting a laser beam from one laser employing a beam splitter.
